(19) United States
(12) Patent Application Publication
(10) Pub. No.: US 2014/0096433 A1
(43) Pub. Date: Apr. 10, 2014

(54) Fishing Line Sinker

(71) Applicant: Gianni Crestanello, Shamrock Park (NZ)

(72) Inventor: Gianni Crestanello, Shamrock Park (NZ)

(21) Appl. No.: 13/644,508

(22) Filed: Oct. 4, 2012

(51) Int. Cl. A01K 95/00

(52) U.S. Cl. CPC A01K 95/00
USPC 43/17.5; 43/43.1

(57) ABSTRACT

A fishing line sinker comprises a length of inelastic material being configured into a coil shape comprising an interior diameter being configured to contain a portion of a fishing line therein. The coil shape further comprises a plurality of coil loops in which spacing between adjacent loops is alterable by transient application of a force. An alteration to a surface of the inelastic material is applied to the inelastic material for gripping at least during placement of the coils shape on the fishing line and application of the force.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to fishing equipment. More particularly, one or more embodiments of the invention relate to a coiled sinker.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. It is believed that one of the hassles of stray-lining when fishing is the regular need to change sinkers in an attempt to maintain the bait in the strike zone. One can expect that as the tidal flow increases or decreases more or less weight may need to be added or removed to the line to generally keep the bait in the area where the fish are believed to be. This usually requires cutting the line, adding or removing a weight or sinker, and then retying the line, which can be quite time consuming.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, an aspect of the prior art generally useful to be aware of is that there are some currently available sinkers that allow for the adjustment of weight on the line including, without limitation, snap on fishing sinkers. There are also available torpedo shaped sinkers with grooves down the middle that can hold the line in place with lugs on either end that bend over the line or an elastic band down the middle. The small sinkers with lugs can typically only be used once as the line generally must be cut to remove the sinkers, and the large sinkers of this type can typically only be used a few times before the lugs break off. Torpedo shaped sinkers held in place with elastic bands are generally lost when there is a fish on the end of the line thrashing about. Yet another currently available sinker comprises a plastic sleeve with a stopper on one end and a nut on the other end. The sleeve is fitted onto the fishing line, and lead weight sinkers with large holes in the center can be fitted over the sleeve with a smaller groove on one side. To fit this type of sinker, a nut is removed from the sleeve and slid up the line, and the sinker is slipped over the line and onto the sleeve. Then, the nut is fitted back onto the sleeve. It is believed that some users may find these sinkers cumbersome to use. Many of the sinkers currently available are expensive and may require the user to stock a multiplicity of different weight sizes.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagrammatic side view of an exemplary lead coil fishing sinker, in accordance with an embodiment of the present invention;

FIGS. 2A and 2B illustrate exemplary coil sinkers in use on a fishing line, in accordance with embodiments of the present invention. FIG. 2A is a diagrammatic side view of a sinker on the line, and FIG. 2B is a diagrammatic side view of a sinker in use on the line with stopper beads;

FIG. 3 is a cross sectional side view of an exemplary coil sinker, in accordance with an embodiment of the present invention;

FIGS. 4A and 4B illustrate an exemplary coil sinker with a flattened profile, in accordance with an embodiment of the present invention. FIG. 4A is a diagrammatic side view, and FIG. 4B is a diagrammatic end view; and

FIG. 5 is a flowchart illustrating an exemplary method for using a coil sinker, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

One embodiment of the present invention comprises a length of lead coil that can be cut to various lengths for different weights and that can be manipulated by pulling and pushing the coils apart or together to generally enable the coil to be fitted onto or removed from a fishing line without cutting the line by winding the coil on or off the fishing line. The coil acts like a sinker on the fishing line to approximately maintain a baited hook in a strike zone at the bottom of the water column. Some embodiments can enable recreational fishermen to effortlessly add and remove the sinker from the line without cutting the line and to determine a personalized weight for the sinker as a wide range of sinker weights are available in one coil. Some embodiments are easy and quick to use and also may be economical to manufacture.

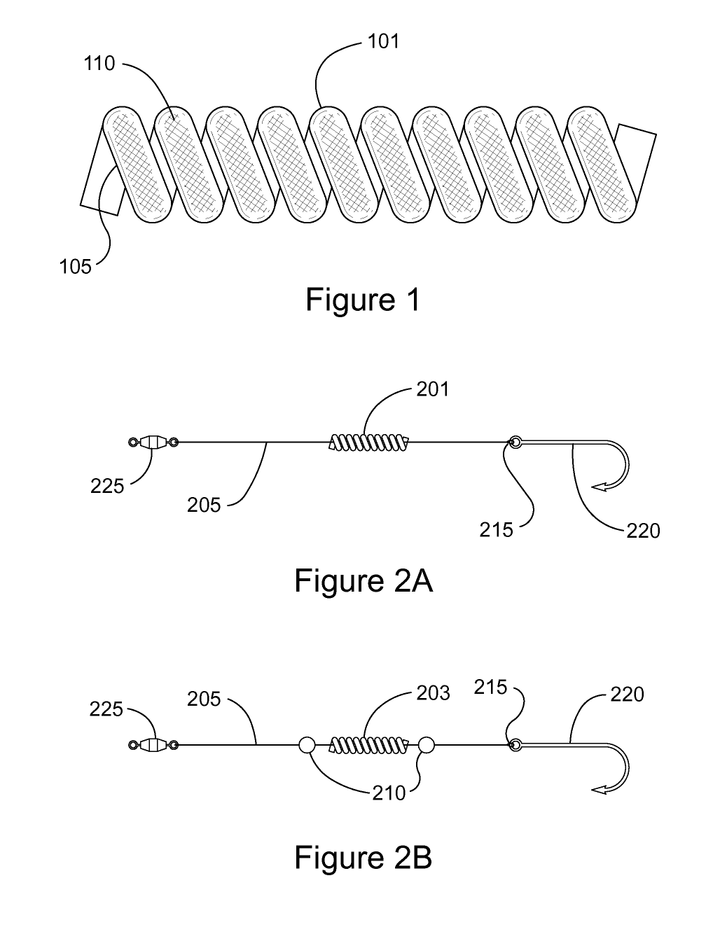

FIG. 1 is a diagrammatic side view of an exemplary lead coil fishing sinker, in accordance with an embodiment of the present invention. In the present embodiment, the sinker comprises a length of lead coil 101. Lead is used, as it provides sufficient weight and has plastic properties that typically allow for the sinker to be cut to various lengths for different weights and to be manipulated by pulling and pushing the coils apart or together. This generally enables the sinker to be fitted onto or removed from a fishing line without cutting the line. Those skilled in the art will readily recognize, in light of and in accordance with the teachings of the present invention, that a multiplicity of suitable materials have appropriate properties of weight and plasticity to be used for the coils in some alternate embodiments such as, but not limited to, various different metals, natural rubber, silicone rubber, some plastics, etc.

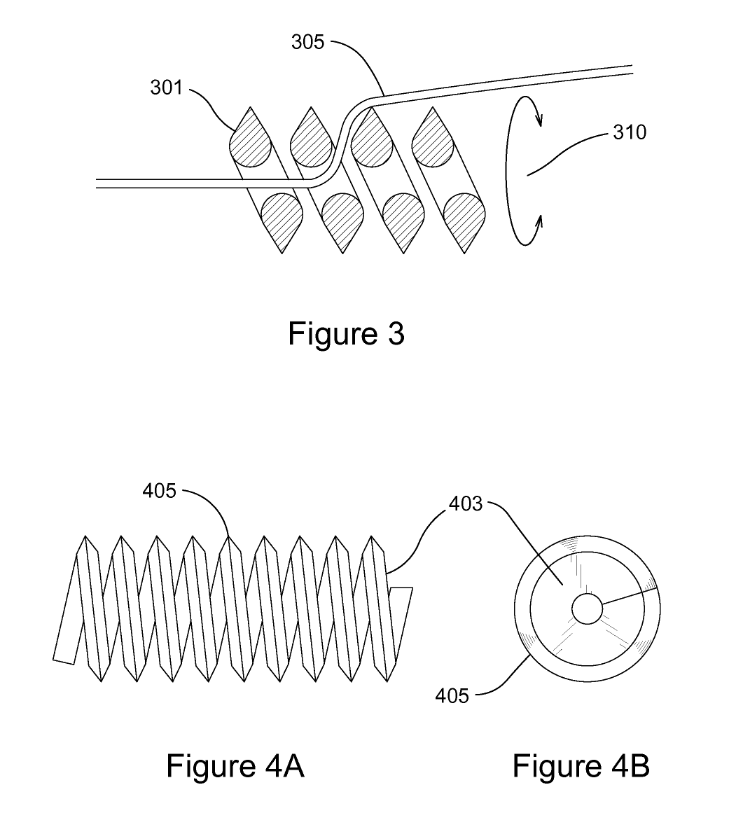

In the present embodiment the lead coil sinker is tightly wound with an internal diameter 105 small enough to generally prevent the sinker from slipping over a knot and eye of a hook and a swivel, as shown by way of example in FIGS. 2A. In some embodiments, a larger internal diameter may be used in combination with plastic beads, as shown by way of example in FIG. 2B. In the present embodiment, a knurled finish 110 is included, without limitation, on top of coil 101, which has a rounded profile. Knurled finish 110 helps to provide a better grip when adjusting coil 101 for application onto or removal from a fishing line. It is contemplated that a multiplicity of suitable means may be used in some embodiments to aid in grip including, without limitation, different types of textured surfaces, non-slip coatings, or changing the profile of the coil wire as illustrated by way of example in FIGS. 3 through 4B. Some alternate embodiments may be implemented with a rounded profile and no means for added grip. In typical use of the present embodiment, coil 101 acts as a sinker on a fishing line to generally maintain a baited hook near the bottom of the water column.

FIGS. 2A and 2B illustrate exemplary coil sinkers 201 and 203 in use on a fishing line 205, in accordance with embodiments of the present invention. FIG. 2A is a diagrammatic side view of sinker 201 on line 205, and FIG. 2B is a diagrammatic side view of sinker 203 in use on line 205 with stopper beads 210. In the present embodiments, sinker 201 or 203 is typically fitted onto fishing line 205 by winding line 205 into the coils of sinker 201 or 203. Then, the coils are pressed together to secure sinker 201 or 203 onto line 205. To remove sinker 201 or 203, the coils are generally pulled apart, or a blunt plastic knife may be placed between the coils, to open the coils so that line 205 may be unwound from sinker 201 or 203. Referring to FIG. 2A, sinker 201 comprises a tightly wound coil of minimal internal diameter, which generally prevents sinker 201 from slipping over a knot 215, the eye of a hook 220 or a swivel 225. Referring to FIG. 2B, in another embodiment, plastic beads 210 can be fitted over fishing line 205 on either side of coil sinker 203, enabling sinker 203 to have a larger internal diameter. Plastic beads generally prevent sinker 203 from slipping over knot, 215, the eye of hook 220 or swivel 225. Once in place on line 205, if a lighter weight is required, a user may cut a portion of sinker 201 or 203 in the weight required with scissors or a knife, and if more weight is needed, the user may easily add another sinker of the appropriate weight onto line 205. This coil sinker takes away some of this hassle as it is a simple matter to wind another weight on or off. This typically removes the hassle of carrying multiple sinkers of different sizes.

FIG. 3 is a cross sectional side view of an exemplary coil sinker, in accordance with an embodiment of the present invention. In the present embodiment, the sinker comprises a wire with a tear shaped profile 301. This profile may provide enhanced grip for pushing the coils together or pulling the coils apart. In typical use of the present embodiment, a fishing line 305 is applied to the sinker by being wound in a counter clockwise direction as indicated by arrows 310. Alternate embodiments may be attached by winding the line in the opposite direction depending on the configuration of the coils of the sinker.

FIGS. 4A and 4B illustrate an exemplary coil sinker with a flattened profile, in accordance with an embodiment of the present invention. FIG. 4A is a diagrammatic side view, and FIG. 4B is a diagrammatic end view. One may expect that when the diameter of the coil wire is greater than 4 mm, it may become difficult to push or pull the coils apart or together. By changing the profile of the sinker to a profile similar to that of a flat washer, the thickness of the material can be reduced while providing more weight per given length. This profile comprises a flat center portion 403 with a pointed edge 405. Pointed edge 405 typically provides an enhanced grip, and this coupled with the reduction in thickness generally allows for easier manipulation of the coils. With better grip on lighter coils and easier manipulation of heavier coils as provided by features such as, but not limited to, varied profiles, textured surfaces, etc., a user can easily add or remove sinkers according to some embodiments of the present invention without cutting the fishing line, which can generally eliminate the need to carry a stock of differently sized sinkers. In some alternate embodiments, the sinker may be implemented with various different profiles such as, but not limited to, rectangular profiles, triangular profiles, elliptical profiles, diamond shaped profiles, etc.

Those skilled in the art will readily recognize, in light of and in accordance with the teachings of the present invention, that some alternate embodiments may comprise various different and additional features such as, but not limited to, a luminous coating, colored coatings, weight markers, means for fastening the sinker to the line including, without limitation, nuts or clamps, finger grip areas, notches to allow for length modification, etc. Furthermore, some alternate embodiments may be implemented with wire of varying thickness so that the weight of the coil is not evenly distributed. Other alternate embodiments may comprise portions where the material is coiled along with portions in which the material is not coiled. For example, one such embodiment may comprise a straight portion with two coiled portions, with one coiled portion at each end of the straight portion. Another such embodiment may comprise a coiled portion with a straight portion extending from each end. In some embodiments the non-coiled portions may be implemented with various different shapes such as, but not limited to, flattened plates, spheres, torpedo shapes, egg shapes, etc.

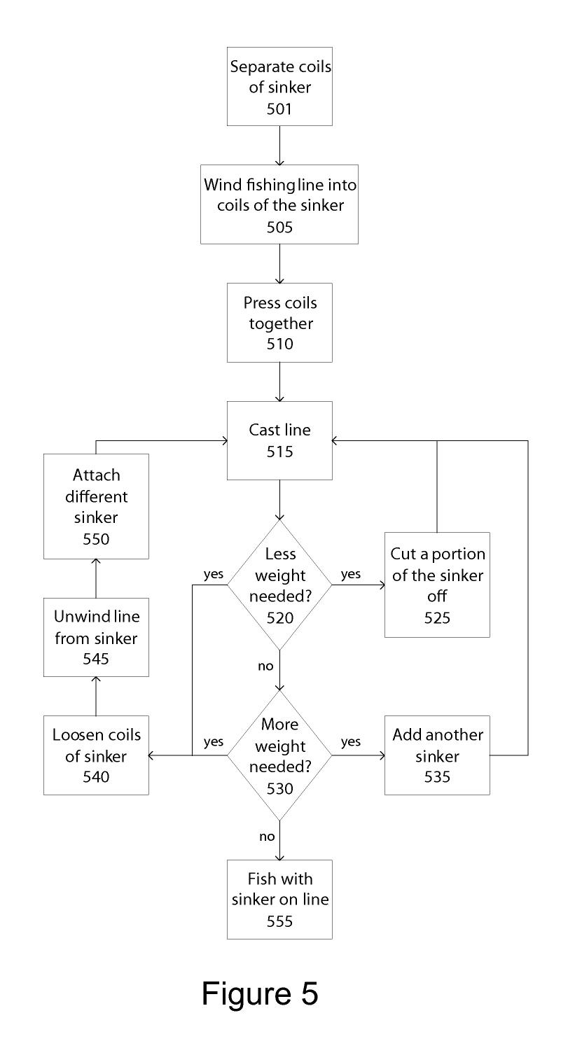

FIG. 5 is a flowchart illustrating an exemplary method for using a coil sinker, in accordance with an embodiment of the present invention. In typical use of the present embodiment, the coils of the sinker are manually separated or a blunt plastic knife may be placed between the coils to create space between the coils to enable a fishing line to fit between the coils in step 501. Step 501 may be skipped if there is already enough space between the coils for the line. Then in step 505, the sinker is fitted onto the fishing line by winding the line into the coils of the sinker. Then, the coils of the sinker are pressed together to secure the sinker onto the line in step 510. If there are beads on the line to generally prevent the sinker from slipping over the eye of the hook or the swivel, the coils do not need to be pressed together as tightly as when no beads are used. Once the sinker is in place on the line, the line may be cast into the water in step 515 so that the sinker maintains the bait in a desired strike zone. If the correct sinker weight is not chosen or if conditions such as, but not limited to, the tide change so that the sinker is not maintaining the bait in the desired area, the sinker weight may be modified without cutting the line. If a lighter weight is required in step 520, the sinker is removed from the water and a portion of the sinker may be cut off with scissors or a knife in step 525. Then the line is recast in step 515. If more weight is needed in step 530, an additional sinker of the appropriate weight may be wound onto the line in step 535, and the line is recast in step 515. Alternatively, if more or less weight is needed in step 520 or 530, the sinker may be removed and replaced with a different sinker without cutting the line. To remove the sinker, the coils of the sinker are loosened in step 540. Then, in step 545, the line is unwound from the sinker. Then a different sinker may be attached to the line in step 550. Once a suitable sinker weight is obtained, the line and attached sinker may be used for fishing in step 555.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing a coil sinker according to the present invention will be apparent to those skilled in the art. The invention has been described above by way of illustration, and the specific embodiments disclosed are not intended to limit the invention to the particular forms disclosed. For example, the particular implementation of the sinker may vary depending upon the particular type of coil used. The coils described in the foregoing were directed to circular implementations forming substantially cylindrically shaped sinkers; however, similar techniques are to use coils of various different shapes such as, but not limited to, semicircular, rectangular or triangular coils to form sinkers with one or more flat sides. Non-circular implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A fishing line sinker comprising:
a length of inelastic material being configured into a coil shape comprising an interior diameter being configured to contain a portion of a fishing line therein, said coil shape further comprising a plurality of coil loops in which a spacing between adjacent loops is alterable by transient application of a force; and
an alteration to a surface of said inelastic material being applied to said inelastic material for gripping at least during placement of said coils shape on the fishing line and application of the force.

2. The fishing line sinker as recited in claim 1, in which said alteration comprises a finish.

3. The fishing line sinker as recited in claim 2, in which said finish is knurled.

4. The fishing line sinker as recited in claim 1, in which said alteration comprises a ridge extending along said length where said ridge extends outward from said coil shape.

5. The fishing line sinker as recited in claim 4, in which said ridge is triangular shaped.

6. The fishing line sinker as recited in claim 1, in which said inelastic material further comprises a flat portion where said flat portion extends inward from said coil shape forming a profile similar to a flat washer.

7. The fishing line sinker as recited in claim 1, in which said coil shape comprises a circular profile.

8. The fishing line sinker as recited in claim 1, in which said interior diameter is smaller than an eye of a hook or swivel.

9. The fishing line sinker as recited in claim 1, in which said coil shape is joined to the fishing line by a counter clockwise winding of the fishing line.

10. The fishing line sinker as recited in claim 1, in which said inelastic material varies in thickness along said length.

11. The fishing line sinker as recited in claim 1, in which said inelastic material further comprises a luminous coating.

12. The fishing line sinker as recited in claim 1, in which said inelastic material comprises a wire shape.

13. The fishing line sinker as recited in claim 1, in which said inelastic material comprises lead.

14. A fishing line sinker comprising:
means for configuring a coil shape to contain a fishing line therein, in which a spacing between adjacent loops of said coil shape is alterable by transient application of a force; and
means for gripping at least during placement of said coils shape on the fishing line and application of the force.

15. A fishing line sinker comprising:
a length of inelastic material comprising a wire shape being configured into a coil shape comprising a circular profile, a flat portion where said flat portion extends inward from said coil shape forming a profile similar to a flat washer, and an interior diameter being configured to contain a portion of a fishing line therein, said coil shape further comprising a plurality of coil loops in which a spacing between adjacent loops is alterable by transient application of a force, said coil shape being joined to the fishing line by a counter clockwise winding of the fishing line; and
a triangular shaped ridge extending along said length where said ridge extends outward from said coil shape for gripping at least during placement of said coils shape on the fishing line and application of the force.

16. The fishing line sinker as recited in claim 15, further comprising a knurled finish.

17. The fishing line sinker as recited in claim 15, in which said interior diameter is smaller than an eye of a hook or swivel.

18. The fishing line sinker as recited in claim 15, in which said inelastic material varies in thickness along said length.

19. The fishing line sinker as recited in claim 15, in which said inelastic material further comprises a luminous coating.

20. The fishing line sinker as recited in claim 15, in which said inelastic material comprises lead.
